(19) United States
(12) Patent Application Publication
(10) Pub. No.: US 2011/0189560 A1
(43) Pub. Date: Aug. 4, 2011

(54) FUEL CELL SYSTEM

(75) Inventors: Po-Kuei Chou, Hsinchu County (TW); Cheng Wang, Hsinchu County (TW); Yueh-Chang Wu, Hsinchu County (TW)

(73) Assignee: YOUNG GREEN ENERGY CO., HSINCHU COUNTY (TW)

(21) Appl. No.: 12/907,015

(22) Filed: Oct. 18, 2010

(30) Foreign Application Priority Data
Feb. 3, 2010 (CN) 201010113556.3

(51) Int. Cl. H01M 8/04; H01M 8/06

(52) U.S. Cl. 429/421; 429/444

(57) ABSTRACT

A fuel cell system including a hydrogen supply module, a fuel cell module, and a control module is provided. The fuel cell module receives a hydrogen from the hydrogen supply module. The fuel cell module includes a fuel cell unit and a hydrogen storage unit, wherein the hydrogen storage unit and the fuel cell unit are connected with each other. The control module is electrically connected to the fuel cell module for controlling the hydrogen storage unit to store or release the hydrogen.

### CROSS-REFERENCE TO RELATED APPLICATION

This application claims the priority benefit of China application serial no. 201010113556.3, filed on Feb. 3, 2010. The entirety of the above-mentioned patent application is hereby incorporated by reference herein and made a part of this specification.

### BACKGROUND OF THE INVENTION

1. Field of the Invention

The invention relates to a fuel cell system.

2. Description of Related Art

A fuel cell is a device that converts chemical energy into electrical energy through reverse water electrolysis reaction. A proton exchange membrane fuel cell (PEMFC) includes a membrane electrode assembly (MEA) and a hydrogen supply module, wherein the hydrogen supply module supplies hydrogen (H₂) to the MEA such that an electrochemical reaction takes place in the MEA.

Hydrogen may be generated by the hydrogen supply module through reaction between solid NaBH₄ and water. This is a one-shot chemical reaction. Namely, hydrogen is constantly generated until the chemical reaction between solid NaBH₄ and water is completed. Thus, if the MEA could not consume all the hydrogen supplied, the excess unreacted hydrogen is accumulated in the fuel cell, and it may be unsafe to use the fuel cell when the hydrogen becomes too dense.

### SUMMARY OF THE INVENTION

Accordingly, the invention is directed to a fuel cell system with a hydrogen storage unit able to enhance hydrogen use efficiency.

Additional aspects and advantages of the invention will be set forth in part in following description.

According to an embodiment of the invention, a fuel cell system including a hydrogen supply module, a fuel cell module, and a control module is provided. The fuel cell module receives a hydrogen from the hydrogen supply module. The fuel cell module includes a fuel cell unit and a hydrogen storage unit connected with each other. The control module is electrically connected to the fuel cell module for controlling the hydrogen storage unit to store or release the hydrogen.

In summary, the embodiment or embodiments of the invention may have at least one of the following advantages. In an embodiment of the invention, a fuel cell unit stores an excess hydrogen through a hydrogen storage unit, so that the hydrogen content in a fuel cell module may be effectively controlled by the fuel cell system, and accordingly the hydrogen use efficiency may be improved. In addition, the hydrogen storage unit releases the hydrogen to the fuel cell unit when there is no sufficient hydrogen in the fuel cell unit or the hydrogen supply module is replaced, so that the fuel cell unit may have a sufficient hydrogen for carrying on the electrochemical reaction, and accordingly the fuel cell system may stably and continuously generate electricity.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a fuel cell system according to an embodiment of the invention.

FIG. 2 is a diagram of a hydrogen storage unit in FIG. 1.

FIG. 3 is a block diagram of a fuel cell system according to another embodiment of the invention.

FIG. 4 is a partial view of the fuel cell system in FIG. 3.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention may be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

Referring to FIG. 1, a fuel cell system 100 includes a hydrogen supply module 110, a fuel cell module 120, and a control module 130. The hydrogen supply module 110 supplies a hydrogen. The hydrogen supply module 110 may generate the hydrogen by mixing solid NaBH₄ and water. However, the embodiment is not limited thereto. The fuel cell module 120 receives the hydrogen from the hydrogen supply module 110. The fuel cell module 120 includes a fuel cell unit 122 and a hydrogen storage unit 124 connected with each other, wherein the hydrogen is sent to the fuel cell unit 122 to carry out an electrochemical reaction. The control module 130 is electrically connected to the fuel cell module 120.

When the hydrogen supplied by the hydrogen supply module 110 exceeds the quantity desired by the fuel cell unit 122 for carrying out the electrochemical reaction, the control module 130 controls the hydrogen storage unit 124 to store the excess hydrogen from the fuel cell unit 122. Contrarily, when there is no sufficient hydrogen in the fuel cell unit 122, the control module 130 controls the hydrogen storage unit 124 to release the hydrogen, so that the hydrogen flows back into the fuel cell unit 122, and the fuel cell unit 122 carries on with the electrochemical reaction continuously. The hydrogen storage unit 124 is served as a hydrogen buffer storage area in the fuel cell unit 122 through this operation, such that the hydrogen use efficiency of the fuel cell unit 122 is improved and the fuel cell system 100 is allowed to generate electricity stably and continuously.

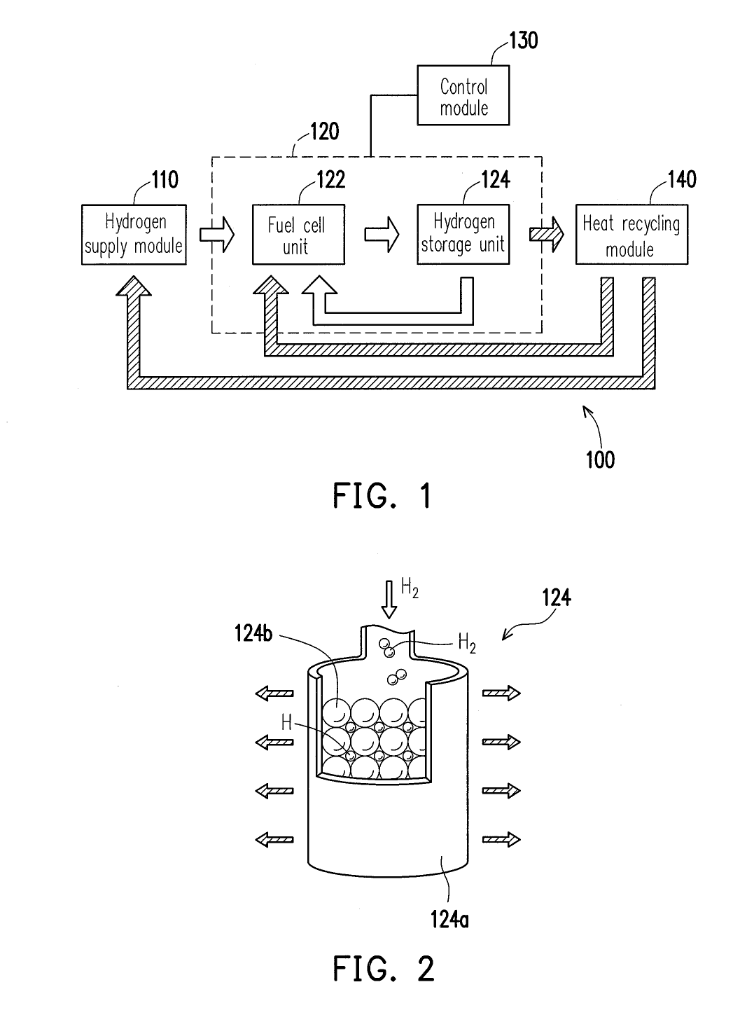

Referring to both FIG. 1 and FIG. 2, in the embodiment, the hydrogen storage unit 124 includes a container 124a and a hydrogen storage material 124b. The container 124a is connected with the fuel cell unit 122, and the hydrogen storage material 124b is disposed in the container 124a. The hydrogen storage material 124b may be a metal hydride, such as LaNi₅ or TiMn₂. However, the embodiment is not limited thereto. The control module 130 controls the hydrogen storage material 124b to store or release the hydrogen by controlling the temperature or pressure within the container 124a.

To be specific, the control module 130 determines whether the sufficient hydrogen is supplied to the fuel cell unit 122 according to characteristic values of the fuel cell unit 122. For example, when there is no sufficient hydrogen in the fuel cell unit 122 or the hydrogen supply module 110 has to be replaced due to fuel exhaustion (i.e., lack of the hydrogen supply module 110), the fuel cell unit 122 generates abnormal signals on voltage, temperature, current, and power or on a combination of these characteristic values. Once these abnormal signals are detected, the control module 130 timely controls the hydrogen storage unit 124 to release the hydrogen so that the fuel cell unit 122 may keep generating electricity. To achieve this function, a plurality of sensors (not shown) may be disposed on the fuel cell module 120, and the control module 130 may sense aforementioned characteristic values through these sensors. However, how the control module 130 obtains the characteristic values is not limited in the embodiment.

Additionally, in the embodiment, the fuel cell system 100 further includes a heat recycling module 140. The heat recycling module 140 may be a fan. The hydrogen storage unit 124 produces a heat when the hydrogen storage unit 124 stores the hydrogen. The heat recycling module 140 conducts the heat to at least one of the hydrogen supply module 110 and the fuel cell unit 122 so that the reaction efficiency of the hydrogen supply module 110 or the fuel cell unit 122 is increased.

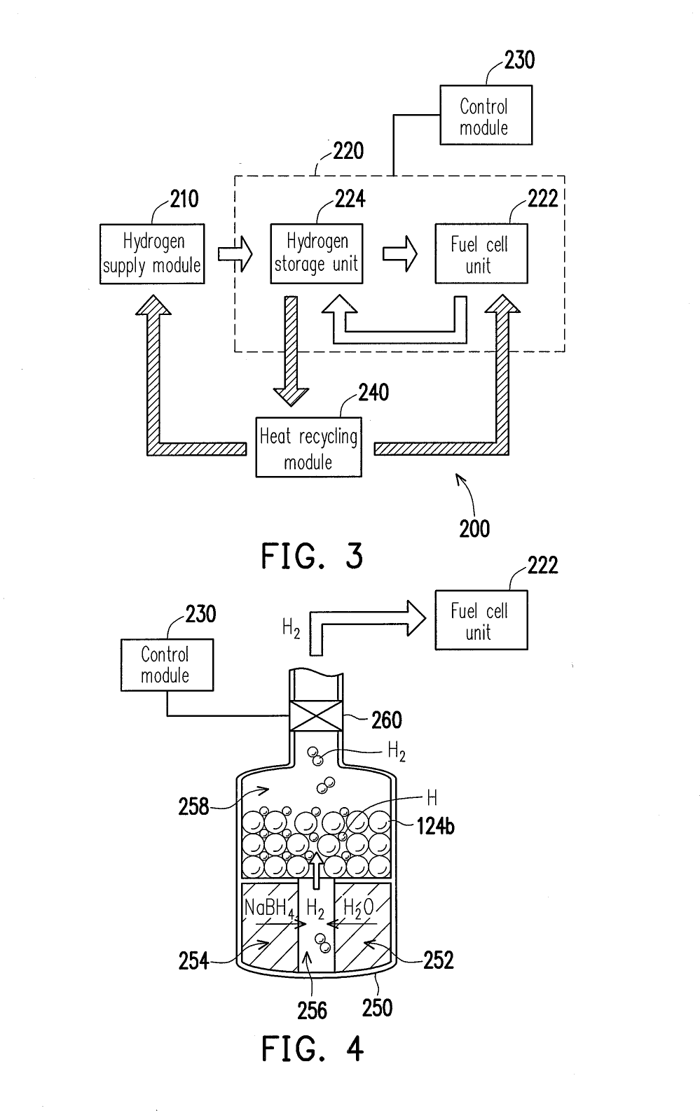

FIG. 3 is a block diagram of a fuel cell system according to another embodiment of the invention. Similar to that described in foregoing embodiment, the fuel cell system 200 includes a hydrogen supply module 210, a fuel cell module 220, a control module 230, and a heat recycling module 240. The differences between the embodiment and the foregoing embodiment are as follows. A hydrogen storage unit 224 is connected between the hydrogen supply module 210 and a fuel cell unit 222. The hydrogen storage unit 224 stores a hydrogen received from the hydrogen supply module 210, and the hydrogen storage unit 224 releases the hydrogen to the fuel cell unit 222. In other words, the fuel cell module 220 may adjust the hydrogen entering the fuel cell unit 222 through the hydrogen storage unit 224.

FIG. 4 is a partial view of the fuel cell system in FIG. 3. Referring to both

FIG. 3 and FIG. 4, in the embodiment, the fuel cell system 200 further includes a cavity 250 connected with the fuel cell unit 222. The cavity 250 has a plurality of compartments 252, 254, 256, and 258, wherein the compartments 252, 254, 256, and 258 respectively contain the hydrogen supply module 210 and the hydrogen storage unit 224. For example, the compartment 254 stores NaBH₄, and the compartment 252 stores water (H₂O). Accordingly, when the NaBH₄ and H₂O are conducted from foregoing two compartments into the compartment 256, hydrogen is generated and conducted toward the compartment 258. The compartment 258 contains the hydrogen storage material 124b so as to receive the hydrogen from the compartment 256 and conduct the hydrogen toward the fuel cell unit 222. Additionally, the fuel cell system 200 further includes a control valve 260 disposed between the cavity 250 and the fuel cell unit 222. The control valve 260 is electrically connected to the control module 230, so that the control module 230 may adjust the hydrogen conducted from the compartment 258 to the fuel cell unit 222 by switching on and off the control valve 260.

In summary, the embodiment or the embodiments of the invention may have at least one of the following advantages. The fuel cell unit stores the excess hydrogen in a hydrogen storage unit, so that the quantity of hydrogen in the fuel cell module may be effectively controlled and the use efficiency of the hydrogen may be improved. In addition, the hydrogen storage unit releases the hydrogen to the fuel cell unit when there is no sufficient hydrogen in the fuel cell unit or the hydrogen supply module is replaced, so that the fuel cell unit may carry on with the electrochemical reaction and the fuel cell system may stably and continuously generate electricity.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A fuel cell system, comprising:
a hydrogen supply module, for supplying a hydrogen;
a fuel cell module, for receiving the hydrogen from the hydrogen supply module, the fuel cell module comprising:
a fuel cell unit;
a hydrogen storage unit, connected with the fuel cell unit; and
a control module, electrically connected to the fuel cell module, for controlling the hydrogen storage unit to store or release the hydrogen.

2. The fuel cell system according to claim 1, wherein the hydrogen storage unit is connected between the hydrogen supply module and the fuel cell unit, the hydrogen storage unit stores the hydrogen from the hydrogen supply module, and the hydrogen storage unit releases the hydrogen to the fuel cell unit.

3. The fuel cell system according to claim 2, wherein the hydrogen storage unit stores an excess hydrogen from the fuel cell unit.

4. The fuel cell system according to claim 2 further comprising:
a cavity, connected to the fuel cell unit, having a plurality of compartments, wherein the compartments respectively contain the hydrogen supply module and the hydrogen storage unit; and
a control valve, disposed between the cavity and the fuel cell unit, wherein the control module is electrically connected to the control valve.

5. The fuel cell system according to claim 1, wherein the fuel cell unit is connected between the hydrogen supply module and the hydrogen storage unit, and the hydrogen storage unit stores the excess hydrogen from the fuel cell unit.

6. The fuel cell system according to claim 1, wherein the hydrogen storage unit comprises:
a container, connected to the fuel cell unit; and
a hydrogen storage material, disposed in the container.

7. The fuel cell system according to claim 6, wherein the hydrogen storage material is a metal hydride.

8. The fuel cell system according to claim 6, wherein the control module controls the hydrogen storage material to store or release the hydrogen by controlling a temperature or a pressure in the container.

9. The fuel cell system according to claim 1, wherein the control module controls the hydrogen storage unit to release the hydrogen to the fuel cell unit by detecting lack of the hydrogen supply module or insufficient hydrogen in the fuel cell unit.

10. The fuel cell system according to claim 1, wherein the control module determines whether the hydrogen is sufficient in the fuel cell unit according to a characteristic value of the fuel cell unit, and the characteristic value is a combination of a voltage, a temperature, a current, and a power of the fuel cell unit.

11. The fuel cell system according to claim 1 further comprising:
a heat recycling module, for conducting a heat produced by the hydrogen storage unit to at least one of the hydrogen supply module and the fuel cell unit.
